(19) United States
(12) Patent Application Publication
(10) Pub. No.: US 2010/0277720 A1
(43) Pub. Date: Nov. 4, 2010

(54) VIRTUAL FENCE SYSTEM AND METHOD

(76) Inventor: Daniel Hammons, Joshua, TX (US)

Correspondence Address: HAYNES AND BOONE, LLP;IP Section, 2323 Victory Avenue, Suite 700, Dallas, TX, 75219, US

(21) Appl. No.: 12/559,068

(22) Filed: Sep. 14, 2009

Related U.S. Application Data
(60) Provisional application No. 61/097,714, filed on Sep. 17, 2008.

(51) Int. Cl. G01N 21/00; G02B 6/00

(52) U.S. Cl. 356/73.1; 385/13

(57) ABSTRACT

A security, monitoring and/or detection system is described. In several exemplary embodiments, the system secures, monitors, and/or detects movement across, a boundary extending across, for example, a relatively large geographic area such as, for example, a transnational border.

### CROSS REFERENCE TO RELATED APPLICATION

This application claims the benefit of the filing date of U.S. patent application Ser. No. 61/097,714, filed Sep. 17, 2008, the entire disclosure of which is incorporated herein by reference.

### BACKGROUND

This disclosure relates in general to security, monitoring and/or detection systems and methods, and in particular to systems and methods for securing, monitoring, and/or detecting movement across, a boundary extending across, for example, a relatively large geographic area such as, for example, a transnational border.

### BRIEF DESCRIPTION OF THE DRAWINGS

FIG. 1 is a schematic view of a system according to an exemplary embodiment, the system including two fiber networks, according to an exemplary embodiment.

FIG. 2 is a schematic top plan view of a segment of the two fiber networks of FIG. 1, according to an exemplary embodiment.

FIG. 3 is a schematic view of a portion of one of the fiber networks of FIGS. 1 and 2, according to an exemplary embodiment, the portion including a surveillance pole, a geothermal heat duct, and a fiber node including a node enclosure, according to respective exemplary embodiments.

FIG. 4 is an enlarged view of the fiber node of FIG. 3, according to an exemplary embodiment.

FIG. 5 is an enlarged view of the surveillance pole of FIG. 3, according to an exemplary embodiment.

FIG. 6 is schematic view of the node enclosure and a portion of the geothermal heat duct of FIG. 3, according to respective exemplary embodiments.

FIG. 7 is another schematic view of the node enclosure of FIG. 6, according to an exemplary embodiment.

FIG. 8 is a schematic view of a sealing element adapted to engage the node enclosure and the geothermal heat duct of FIGS. 6 and 7, according to an exemplary embodiment.

### DETAILED DESCRIPTION

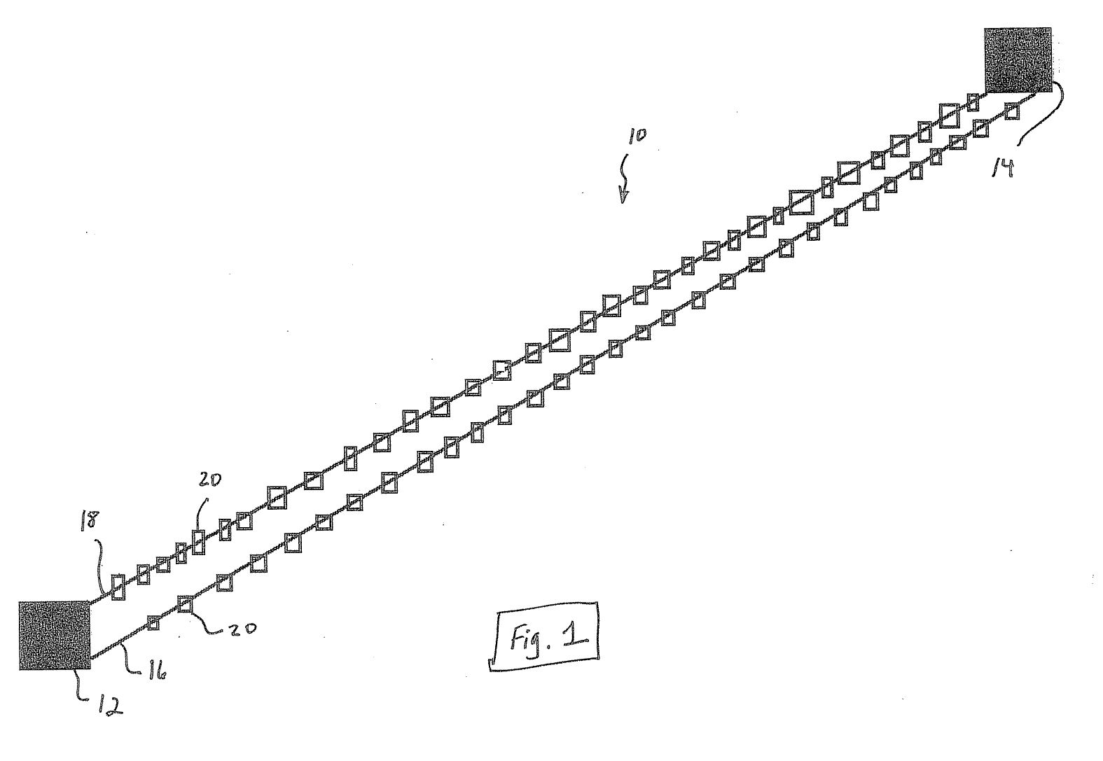

In an exemplary embodiment, as illustrated in FIG. 1, a system is generally referred to by the reference numeral 10 and includes control centers 12 and 14, between which fiber networks 16 and 18 extend. A plurality of fiber nodes 20 are coupled to each of the fiber networks 16 and 18 in an in-line configuration. In an exemplary embodiment, at least respective portions of the fiber networks 16 and 18 are buried underground or at least extend below ground level, and the fiber nodes 20 are at least partially buried underground or at least partly positioned below ground level. In an exemplary embodiment, each of the control centers 12 and 14 is located at and/or above ground level. In an exemplary embodiment, the respective nodes 20 coupled to the network 16 are shifted, relative to the respective locations of the nodes 20 coupled to the network 18, so that each of the respective nodes 20 coupled to the network 16 is positioned, relative to a dimension extending from one of the control centers 12 and 14 to the other of the control centers 12 and 14, either between two nodes 20 coupled to the network 18, or between one node 20 coupled to the network 18 and one of the control centers 12 and 14. As a result, the respective locations of the nodes 20 are triangulated.

In several exemplary embodiments, additional control centers substantially identical to the control centers 12 and 14 are coupled to one or both of the fiber networks 16 and 18 in an in-line configuration. In several exemplary embodiments, one or both of the control centers 12 and 14 are omitted from the system 10. In several exemplary embodiments, one or more fiber networks substantially identical to one or both of the fiber networks 16 and 18 extend from one or both of the control centers 12 and 14.

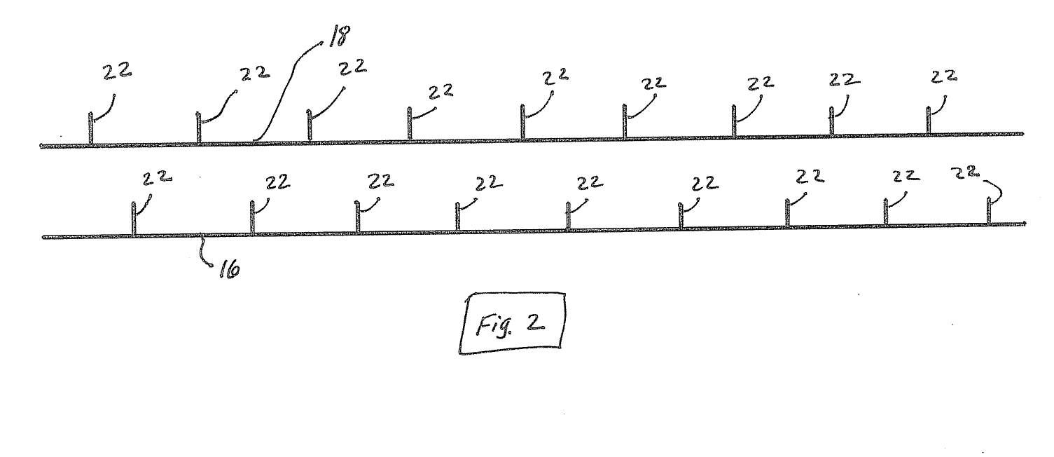

In an exemplary embodiment, as illustrated in FIG. 2 with continuing reference to FIG. 1, a plurality of acoustic/seismic sensors 22 are coupled to each of the fiber networks 16 and 18. In an exemplary embodiment, the sensors 22 are buried underground or at least are positioned below ground level. In an exemplary embodiment, the respective sensors 22 coupled to the network 16 are shifted, relative to the respective locations of the sensors 22 coupled to the network 18, so that each of the respective sensors 22 coupled to the network 16 is positioned, relative to a dimension extending from one of the control centers 12 and 14 to the other of the control centers 12 and 14, either between two sensors 22 coupled to the network 18, or between one sensor 22 coupled to the network 18 and one of the control centers 12 and 14. As a result, the respective locations of the sensors 22 are triangulated, as viewed from the perspective of a top plan view of the system 10 (FIG. 2), such as, for example, a view from the perspective of being above ground level and looking downwards towards the ground.

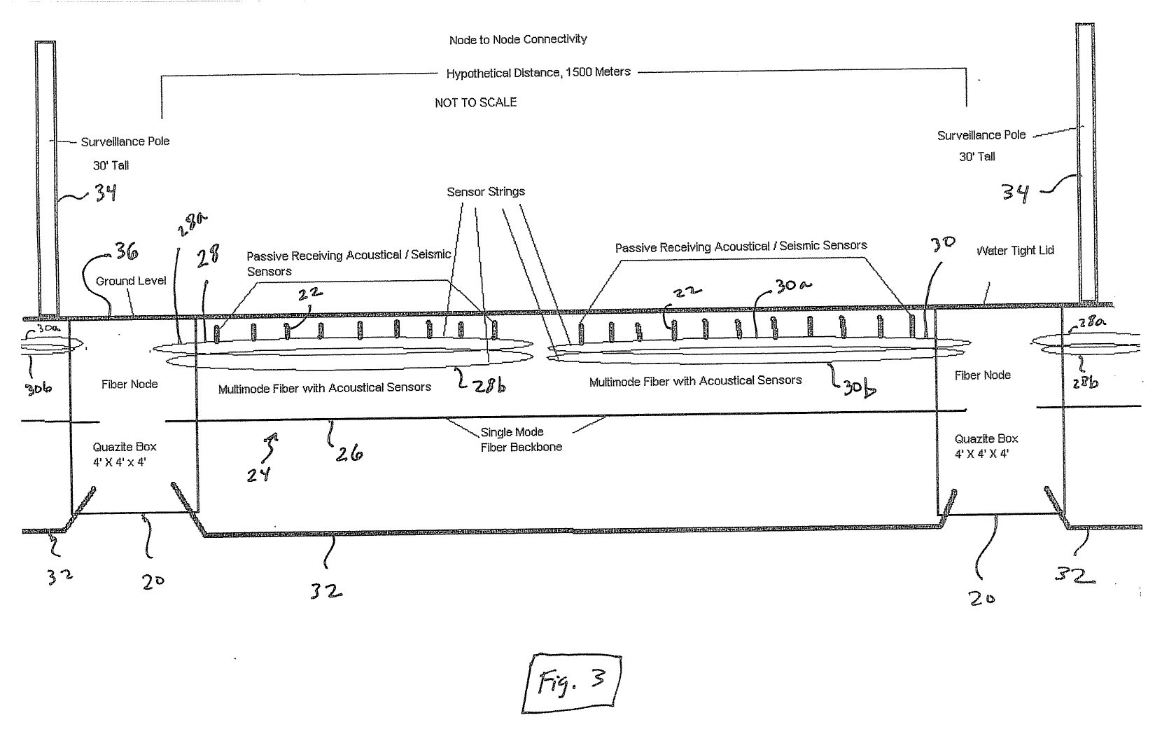

In an exemplary embodiment, as illustrated in FIG. 3 with continuing reference to FIGS. 1 and 2, the fiber network 16 includes a plurality of segments 24, each of which extends between adjacent nodes 20. Each of the segments 24 includes a single mode fiber backbone 26, and sensor strings 28 and 30. The sensor string 28 includes multimode fiber loops 28a and 28b, and the sensor string 30 includes multimode fiber loops 30a and 30b. In an exemplary embodiment, the fiber backbone 26 is, or at least includes in whole or in part single mode fiber optic cable. In an exemplary embodiment, each of the fiber loops 28a, 28b, 30a and 30b is, or at least includes in whole or in part, multimode fiber optic cable. The sensors 22 are coupled to each of the loops 28a and 30a. A conduit or duct 32 also extends between the adjacent nodes 20. Immediately above or at least proximate each of the nodes 20, a surveillance pole 34 extends upwards and above a ground level 36. In an exemplary embodiment, the distance between the nodes 20 shown in FIG. 3 is about 1500 meters.

In an exemplary embodiment, the fiber network 18 is substantially similar to the fiber network 16 and therefore the fiber network 18 will not be described in further detail.

In an exemplary embodiment, the fiber networks 16 and 18 are disposed in one or more trenches and buried directly in the ground. In an exemplary embodiment, the fiber networks 16 and 18 extend within ducts, which, in turn extend below the ground level 36. In an exemplary embodiment, trenches are dug and the fiber networks 16 and 18 are disposed directly in the trenches and then buried, or the fiber networks 16 and 18 are disposed in one or more ducts, which, in turn, are disposed directly in the trenches and then buried.

In an exemplary embodiment, as illustrated in FIG. 4 with continuing reference to FIGS. 1, 2 and 3, each of the nodes 20 includes a node enclosure 38 and a water-tight lid 40 coupled thereto. In several exemplary embodiments, the lid 40 or at least a portion thereof is above, at, or below the ground level 36. An electronic driver 42 is operably coupled to the sensor string 30 extending towards the left of the node 20, as viewed in FIG. 4. Each of the loops 30a and 30b extends from the driver 42 and to a point underground and between the node 20 shown in FIG. 4 and the next adjacent node to the left, as viewed in FIG. 4, and then loops back to the driver 42. In an exemplary embodiment, each of the loops 30a and 30b includes two ends, each of which is plugged into the driver 42, so that the driver 42 is part of each of the loops 30a and 30b. An electronic driver 44 is operably coupled to the sensor string 28 extending towards the right of the node 20, as viewed in FIG. 4. Each of the loops 28a and 28b extends from the driver 44 and to a point underground and between the node 20 shown in FIG. 4 and the next adjacent node to the right, as viewed in FIG. 4, and then loops back to the driver 44. In an exemplary embodiment, each of the loops 28a and 28b includes two ends, each of which is plugged into the driver 44, so that the driver 44 is part of each of the loops 28a and 28b. In an exemplary embodiment, each of the drivers 42 and 44 is, or at least includes in whole or in part, a FOM Microphone electronic driver, which type of driver is available from Micro Optics Technologies, Inc., Middleton, Wis. USA. In an exemplary embodiment, each of the sensors 22 is, or at least includes in whole or in part, a FOM1 microphone, which type of microphone is available from Micro Optics Technologies, Inc., Middleton, Wis. USA. In an exemplary embodiment, the driver 42 and one or more of the sensors 22 are, or a least include in whole or in part, a Fibersound fiber optic microphone system, which type of microphone system is available from Micro Optics Technologies, Inc., Middleton, Wis. USA. In an exemplary embodiment, one or more of the driver 42 and the sensors 22 include in whole or in part one or more embodiments, systems, aspects, features and/or components disclosed in U.S. Pat. No. 5,262,884, the disclosure of which is incorporated herein by reference. An analog-to-digital converter 46 is electrically coupled to each of the drivers 42 and 44. A fiber switch 48 is electrically coupled to the converter 46. The fiber backbone 26 is operably coupled to the fiber switch 48 in an in-line configuration. One or more batteries 50 are electrically coupled to each of the drivers 42 and 44, the converter 46, and the switch 48. The drivers 42 and 44, the converter 46, the switch 48, and the batteries 50 are housed in an interior region 38a defined by the enclosure 38. A signal line 52 is electrically coupled to the fiber switch 48, and extends into an internal passage 34a defined by the pole 34, and further extends upwards to one or more components supported by the pole 34, which components will be described in further detail below. A signal line 54 is electrically coupled to the fiber switch 48, and extends into the passage 34a of the pole 34, and further extends upwards to one or more components supported by the pole 34, which components will be described in further detail below. The enclosure 38 is coupled to the duct 32 in an in-line configuration so that the interior region 38a of the enclosure 38 fluidicly couples the segment of the duct 32 extending to the right of the node 20, as viewed in FIG. 4, to the segment of the duct 32 extending to the left of the node 20, as viewed in FIG. 4.

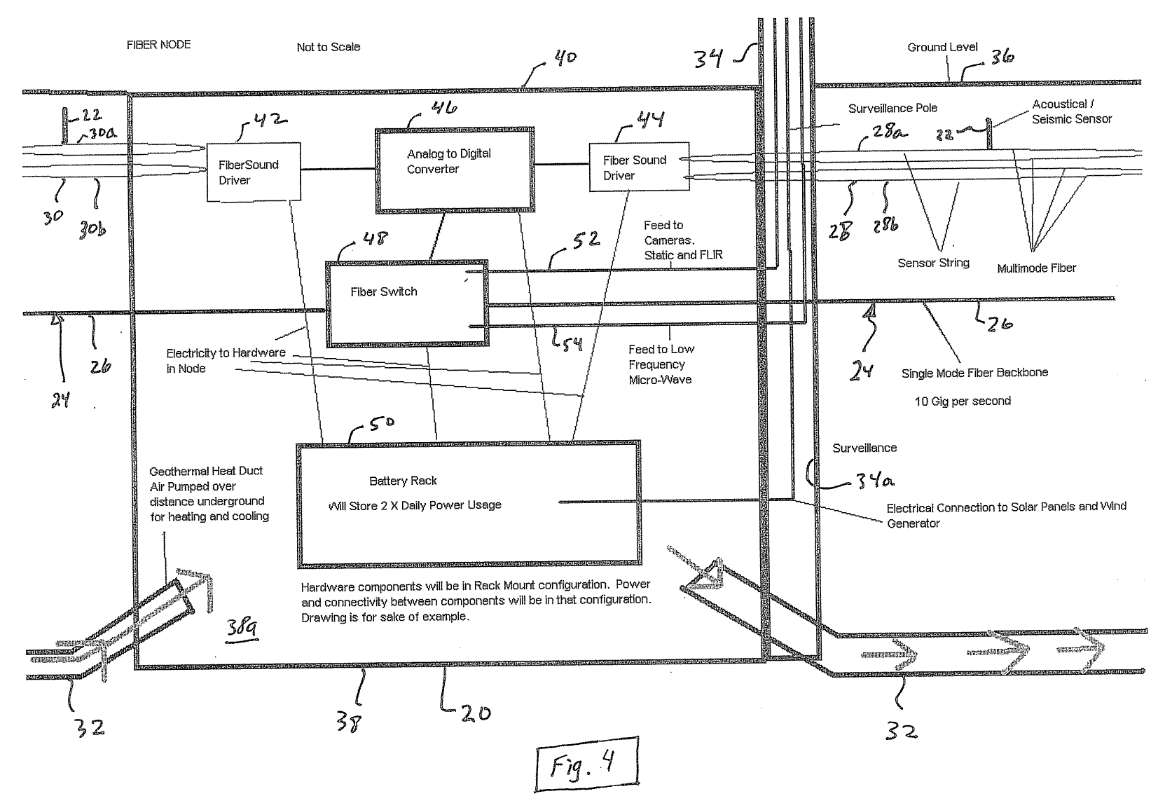

In an exemplary embodiment, as illustrated in FIG. 5 with continuing reference to FIGS. 1, 2, 3 and 4, the following components are mounted to the pole 34: a forward looking infrared (FLIR) camera 56, a solar panel 58, a radio omni antenna 60, a windmill power generator 62, motion-activated cameras 64, motion sensors 66, and a secure steel H box 68. The panel 58 and the generator 62 are electrically coupled to the batteries 50. In an exemplary embodiment, the motion sensors 66 are low frequency microwave motion sensors which detect motion and indicate speed and direction. In an exemplary embodiment, there are four cameras 64, which are mounted on horizontal masts, and each of which cover 90 degrees. In an exemplary embodiment, the signal line 54 is electrically coupled to the motion sensors 66. In an exemplary embodiment, the signal line 52 is electrically coupled to the cameras 64, and the camera 56.

In an exemplary embodiment, the enclosure 38 is a Quazite box. In an exemplary embodiment, the enclosure is 4 feet by 4 feet by 4 feet. In an exemplary embodiment, the enclosure 38 is composed of Quazite, concrete, fiberglass, and/or any combination thereof.

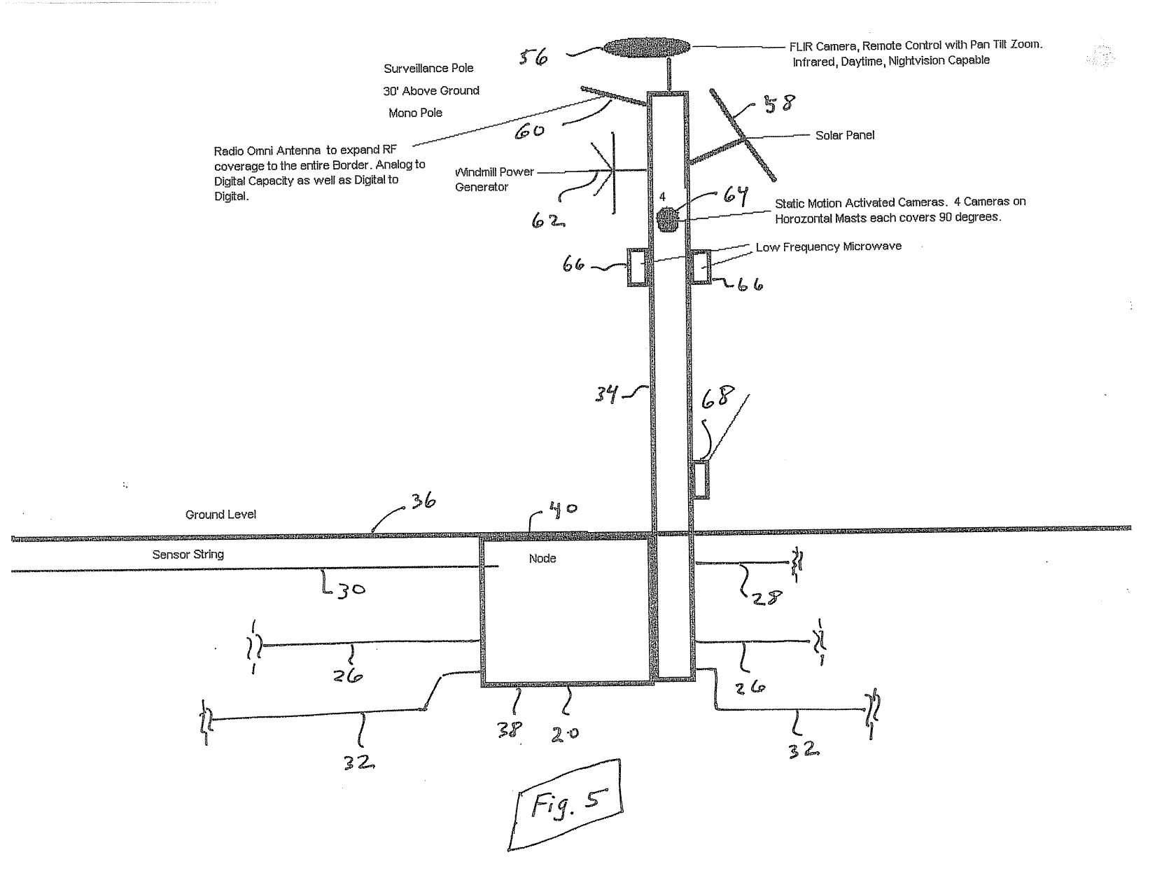

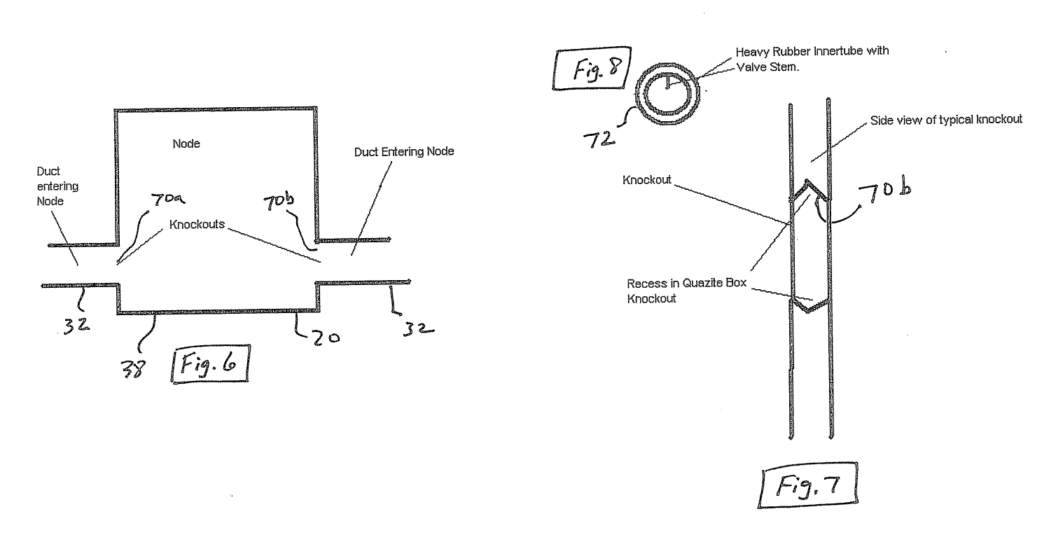

In an exemplary embodiment, as illustrated in FIGS. 6, 7 and 8 with continuing reference to FIGS. 1, 2, 3, 4 and 5, knockout recesses 70a and 70b are formed in the enclosure 38 of the node 20. The respective segments of the duct 32 extend into, or at least to, the enclosure 38 via the knockout recesses 70a and 70b. Annular sealing elements, such as inner tubes 72, are installed in the knockout recesses 70a and 70b, respectively, and circumferentially extend about the respective segments of the duct 32. The inner tubes 72 are inflated, sealingly engaging both the enclosure 38 and the respective segments of the duct 32. As a result, water or other foreign material is substantially prevented from entering the enclosure 38 of the node 20.

In operation, in an exemplary embodiment, the system 10 secures, monitors, and/or detects movement across, a boundary extending across, for example, a relatively large geographic area such as, for example, a transnational border. In several exemplary embodiments, in response to detecting motion across the boundary, the system 10, inter alia, sounds an alarm, provides information to Border Patrol personnel regarding the intrusion across the border, directly dissuades the intruder or intruders from continuing to cross the border by sounding alarms, playing messages, etc., and/or any combination thereof. As a result, in several exemplary embodiments, the system 10 operates as a virtual fence.

In an exemplary embodiment, the system 10 is positioned along a transnational border, with the length of the border determining, inter alia, the needed quantity of nodes 20 and the needed quantity of control centers, including the control centers 12 and 14.

In an exemplary embodiment, the driver 44 sends identical light through the loops 28a and 28b. If the sensors 22 coupled to the loop 28a sense noise from, for example, one or more persons and/or vehicles crossing the boundary, then the sensors 22 operate as passive one-way receivers that pick up the noise, which, in turn, affects the light beam sent out by the driver 44 and creates an operating parameter of the loop 28a, such as a frequency. In contrast, the loop 28b only runs constant light, sent by the driver 44, at a fixed frequency. The driver 44 compares the respective frequencies of the loops 28a and 28b, and then sends one or more analog signals to the converter 46, which signals correspond to the comparison of the frequencies. The converter 46 then converts the one or more analog signals into one or more digital signals, and then transmits the digital signals to the fiber switch 48, which, in turn, sends data or information corresponding to the digital signals to one or more of the control centers 12 and 14, and/or other control centers, via the backbone 26. The backbone 26 is carriers data such as, for example, voice or video data. In an exemplary embodiment, in response to the detection of noise by one or more of the sensors 22, an operator at the control center 12 or 14, turns on one or more of the cameras 56 and 64, or the cameras are automatically turned on.

In an exemplary embodiment, the sensors 22 convert acoustic signals to a modulated light intensity signal. The driver 44 compares respective operating parameters of the loops 28a and 28b, such as, for example, the respective light intensity signals of the loops 28a and 28b, and then sends one or more analog signals to the converter 46, which signals correspond to the comparison of the respective operating parameters. The converter 46 then converts the one or more analog signals into one or more digital signals, and then transmits the digital signals to the fiber switch 48, which, in turn, sends data or information corresponding to the digital signals to one or more of the control centers 12 and 14, and/or other control centers, via the backbone 26. The backbone 26 carriers data, such as, for example, voice or video data. In an exemplary embodiment, in response to the detection of noise by one or more of the sensors 22, an operator at the control center 12 or 14, turns on one or more of the cameras 56 and 64, or the cameras are automatically turned on.

In an exemplary embodiment, the driver 44 launches unmodulated light to the sensors 22 via the loop 28a, and converts the returned, audio modulated light to an electrical audio signal. In an exemplary embodiment, the driver 44 launches unmodulated light into the loop 28b, which light returns to the driver 44.

In an exemplary embodiment, one or more of the operating parameters of the loop 28b serves as a baseline against which corresponding one or more operating parameters of the loop 28a are compared. In several exemplary embodiments, different types of noise in the vicinity of the boundary, such as animal noises and/or background noises, are filtered out by one or more of the drivers 42 and 44, the control centers 12 and 14, other components in the system 10, and/or any combination thereof.

The operation of each of the driver 42, and the loops 30a and 30b, is substantially similar to the operation of each of the driver 44, and the loops 28a and 28b, respectively, and therefore the operation of each of the driver 42, and the loops 30a and 30b, will not be described in further detail.

In an exemplary embodiment, if motion is detected by the cameras 64, then the cameras 64 are turned on. In an exemplary embodiment, if motion is detected by the sensors 66, then this detection is sent to the control center 12 or 14 via the line 54, the switch 48 and the backbone 26. In response, an operator at the control center 12 or 14 turns on one or more of the cameras 56 and 64, or the cameras are automatically turned on.

In an exemplary embodiment, the operation of the system 10 includes different detection types or modes, such as, for example, acoustic/seismic sensing using the sensors 22, low frequency microwave sensing using the sensors 66, and motion sensing using the cameras 64. In an exemplary embodiment, an alarm light and/or speaker mounted on the pole 34 is activated in response to the detection of motion. In an exemplary embodiment, the node 20 is powered by the windmill power generator 62 and/or the solar panel 58. Power from the generator 62 and/or the panel 58 is stored in the batteries 50. In an exemplary embodiment, the secure steel H box 68 permits an operator to plug into the fiber network 16 or 18, thereby permitting the operator to communicate and/or transmit data via the network, including sending e-mail messages, having voice conversations using voice over internet protocol (VoIP), sending videos, and/or engaging in other types of communication or data transmissions. In an exemplary embodiment, one or more remote user interfaces and/or control centers are operably coupled to, and in two-way communication with, the control center 12 or 14 via a network, such as the Internet, any type of local area network, any type of wide area network, any type of wireless network, and/or any combination thereof.

In an exemplary embodiment, the duct 32 is a geothermal heat duct, which provides heating or cooling to the respective interior regions 38a of the enclosures 38 of the nodes 20. In an exemplary embodiment, warm or cool air is pumped through the duct 32 to provide heating or cooling, respectively. In an exemplary embodiment, one or more heat pumps are fluidicly coupled to the duct 32.

A system has been described that includes one or more fiber optic cables buried underground and at least proximate a boundary between at least two areas, the one or more fiber optic cables having one or more operating parameters; and a driver for detecting the one or more operating parameters. In an exemplary embodiment, the at least two areas comprise first and second nation states, and the boundary comprises a transnational boundary between the first and second nation states. In an exemplary embodiment, the first and second fiber optic cables extend in a direction generally corresponding to the direction of extension of the boundary between the at least two areas.

A system has been described that includes first and second fiber optic cables located below a ground level and at least proximate a boundary between at least two areas; and a driver operably coupled to the first and second fiber optic cables and located below the ground level. In an exemplary embodiment, the at least two areas are first and second nation states, respectively, and the boundary is a transnational boundary between the first and second nation states. In an exemplary embodiment, the first and second fiber optic cables extend in a direction generally corresponding to the direction of extension of the boundary between the at least two areas.

A method has been described that includes burying first and second fiber optic cables in the vicinity of a boundary between at least two areas; and detecting motion in the vicinity of the boundary between the at least two areas, comprising determining a first operating parameter of the first fiber optic cable; and comparing the first operating parameter with a second operating parameter of the second fiber optic cable. In an exemplary embodiment, the at least two areas are first and second nation states, respectively, and the boundary is a transnational boundary between the first and second nation states. In an exemplary embodiment, the first and second fiber optic cables extend in a direction generally corresponding to the direction of extension of the boundary between the at least two areas.

A system has been described that includes means for burying first and second fiber optic cables in the vicinity of a boundary between at least two areas; and means for detecting motion in the vicinity of the boundary between the at least two areas, comprising means for determining a first operating parameter of the first fiber optic cable; and means for comparing the first operating parameter with a second operating parameter of the second fiber optic cable. In an exemplary embodiment, the at least two areas are first and second nation states, respectively, and the boundary is a transnational boundary between the first and second nation states. In an exemplary embodiment, the first and second fiber optic cables extend in a direction generally corresponding to the direction of extension of the boundary between the at least two areas.

A method has been described that includes burying one or more fiber optic cables in the vicinity of a boundary between at least two areas; and detecting motion in the vicinity of the boundary between the at least two areas using the one or more fiber optic cables. In an exemplary embodiment, the at least two areas are first and second nation states, respectively, and the boundary is a transnational boundary between the first and second nation states. In an exemplary embodiment, the first and second fiber optic cables extend in a direction generally corresponding to the direction of extension of the boundary between the at least two areas.

A system has been described that includes means for burying one or more fiber optic cables in the vicinity of a boundary between at least two areas; and means for detecting motion in the vicinity of the boundary between the at least two areas using the one or more fiber optic cables. In an exemplary embodiment, the at least two areas are first and second nation states, respectively, and the boundary is a transnational boundary between the first and second nation states. In an exemplary embodiment, the first and second fiber optic cables extend in a direction generally corresponding to the direction of extension of the boundary between the at least two areas.

It is understood that variations may be made in the foregoing without departing from the scope of the disclosure.

In several exemplary embodiments, the elements and teachings of the various illustrative exemplary embodiments may be combined in whole or in part in some or all of the illustrative exemplary embodiments. In addition, one or more of the elements and teachings of the various illustrative exemplary embodiments may be omitted, at least in part, and/or combined, at least in part, with one or more of the other elements and teachings of the various illustrative embodiments.

In several exemplary embodiments, any one or more of the above-described embodiments and/or variations may be composed of any one or more of the above-described materials, and/or any combination thereof. In several exemplary embodiments, any one or more of the above-described embodiments and/or variations may be in the form of any one or more of the above-described forms, and/or any combination thereof. In several exemplary embodiments, any one or more of the above-described embodiments and/or variations may have any one or more of the above-described surface structures, and/or any combination thereof. In several exemplary embodiments, any one or more of the above-described embodiments and/or variations may have any one or more of the above-described shapes, and/or any combination thereof.

Any spatial references such as, for example, “upper,” “lower,” “above,” “below,” “between,” “bottom,” “vertical,” “horizontal,” “angular,” “upwards,” “downwards,” “side-to-side,” “left-to-right,” “left,” “right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several exemplary embodiments, while different steps, processes, and procedures are described as appearing as distinct acts, one or more of the steps, one or more of the processes, and/or one or more of the procedures may also be performed in different orders, simultaneously and/or sequentially. In several exemplary embodiments, the steps, processes and/or procedures may be merged into one or more steps, processes and/or procedures. In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

What is claimed is:

1. A system comprising:
one or more fiber optic cables buried underground and at least proximate a boundary between at least two areas, the one or more fiber optic cables having one or more operating parameters; and
a driver for detecting the one or more operating parameters.

2. The system of claim 1 wherein the at least two areas comprise first and second nation states, and the boundary comprises a transnational boundary between the first and second nation states.

3. The system of claim 1 wherein the first and second fiber optic cables extend in a direction generally corresponding to the direction of extension of the boundary between the at least two areas.

4. A system comprising:
first and second fiber optic cables located below a ground level and at least proximate a boundary between at least two areas; and
a driver operably coupled to the first and second fiber optic cables and located below the ground level.

5. The system of claim 4 wherein the at least two areas are first and second nation states, respectively, and the boundary is a transnational boundary between the first and second nation states.

6. The system of claim 4 wherein the first and second fiber optic cables extend in a direction generally corresponding to the direction of extension of the boundary between the at least two areas.

7. A method comprising:
burying first and second fiber optic cables in the vicinity of a boundary between at least two areas; and
detecting motion in the vicinity of the boundary between the at least two areas, comprising:
determining a first operating parameter of the first fiber optic cable; and
comparing the first operating parameter with a second operating parameter of the second fiber optic cable.

8. The method of claim 7 wherein the at least two areas are first and second nation states, respectively, and the boundary is a transnational boundary between the first and second nation states.

9. The method of claim 7 wherein the first and second fiber optic cables extend in a direction generally corresponding to the direction of extension of the boundary between the at least two areas.

10. A method comprising:
burying one or more fiber optic cables in the vicinity of a boundary between at least two areas; and
detecting motion in the vicinity of the boundary between the at least two areas using the one or more fiber optic cables.

11. The method of claim 13 wherein the at least two areas are first and second nation states, respectively, and the boundary is a transnational boundary between the first and second nation states.

12. The method of claim 13 wherein the first and second fiber optic cables extend in a direction generally corresponding to the direction of extension of the boundary between the at least two areas.
